(19) United States
(12) Patent Application Publication
(10) Pub. No.: US 2014/0300964 A1
(43) Pub. Date: Oct. 9, 2014

(54) WIRE GRID POLARIZER WITH SUBSTRATE CHANNELS

(71) Applicants: MARK ALAN DAVIS, SPRINGVILLE, UT (US); MIKE BLACK, OREM, UT (US); STEVEN GRIMMETT, PLEASANT GORVE, UT (US); RON WINKS, MERIDIAN, ID (US)

(72) Inventors: MARK ALAN DAVIS, SPRINGVILLE, UT (US); MIKE BLACK, OREM, UT (US); STEVEN GRIMMETT, PLEASANT GORVE, UT (US); RON WINKS, MERIDIAN, ID (US)

(21) Appl. No.: 13/326,566

(22) Filed: Dec. 15, 2011

Related U.S. Application Data
(60) Provisional application No. 61/428,555, filed on Dec. 30, 2010.

(51) Int. Cl. G02B 5/30; B44C 1/22

(52) U.S. Cl. 359/485.05; 216/24

(57) ABSTRACT

A wire grid polarizer with substrate channels comprising an array of substantially parallel channels extending into a substrate. An array of substantially parallel ribs is defined between the array of channels and integral with and extend from the substrate. The channels contain at least one material to form an array of substantially parallel wires. The ribs separate the wires into separate and discrete wires.

### CLAIM OF PRIORITY

This claims priority to U.S. Patent Application Ser. No. 61/428,555, filed Dec. 30, 2010; which is hereby incorporated herein by reference in its entirety.

### BACKGROUND

Wire grid polarizers are frequently used for polarizing infrared, visible, and ultraviolet light. Wire grid polarizers can be comprised of a transparent substrate with an array of substantially parallel, discrete wires. A pitch, comprising a width of a wire and a distance between wires, is normally less than about half of the wavelength of incoming light, for efficient polarization.

Improved polarization has been shown by etching into the substrate between the wires, thus forming substrate ribs beneath the wires. For example, see U.S. Pat. No. 6,122,103.

Due to the small size of the wires on top of the substrate, wire grid polarizers can be easily damaged, such as by handling. The damage can be toppling of wires, thus causing the wire grid polarizer to lose polarization ability in damaged areas. It would be desirable to have a more durable wire grid polarizer that could be handled more easily.

Wires can also topple during manufacturing if an aspect ratio, defined as wire height divided by width of either the wire or the gap between the wires, is too high. A high aspect ratio is desirable to minimize undesirable transmission of the polarization Tₛ that the polarizer is designed to reflect. Transmission of desirable polarization is often called Tₚ. It is desirable in a polarizer to have high contrast, defined as Tₚ/Tₛ. Contrast is an indication of the effectiveness of transmitting the desirable polarization Tₚ while preventing polarization of undesirable polarization Tₛ. Thus a polarizer with a higher aspect ratio can provide for better contrast.

Wires can also corrode because three sides of wires can be exposed to a corrosive environment. Various methods, such as coating the wires with a corrosion protective coating, have been proposed. For example, see U.S. Pat. No. 6,785,050.

Other related wire grid polarizer publications include U.S. Pat. Nos. 5,412,502, 7,158,302, and 7,692,860; and U.S. patent publication numbers 20070242187, 20090041971, 20090046362, and 20090053655.

### SUMMARY

It has been recognized that it would be advantageous to have a more durable wire grid polarizer with higher contrast. It has also been recognized that it would be advantageous to have a polarizer that is less susceptible to damage by corrosion. The present invention is directed to a wire grid polarizer that satisfies the needs for less susceptibility to damage by corrosion, increased durability, and/or higher contrast.

The device comprises a substrate with an array of substantially parallel channels extending into the substrate from a top of the substrate. An array of substantially parallel ribs is defined between the array of channels and is integral with and extends from the substrate. The channels can contain at least one material forming an array of substantially parallel wires. The wires can be made of a material that will aid in polarization of incoming light. The ribs can separate the wires into separate and discrete wires.

In one embodiment, wires terminate below a top surface of the substrate ribs. In another embodiment, some of the channels can be deeper than other channels.

The above design can allow for a more durable wire grid polarizer because substrate ribs can support the wires. Channel walls can partially protect the wires from corrosion.

### BRIEF DESCRIPTION OF THE DRAWINGS

FIG. 1 is a schematic cross-sectional side view of a wire grid polarizer, showing wires in the channels, in accordance with an embodiment of the present invention;

FIG. 2 is a schematic cross-sectional side view of a wire grid polarizer, with wires that comprise at least three different materials in each channel, forming a stack of layers with one layer disposed on top of another layer, in accordance with an embodiment of the present invention;

FIG. 3 is a schematic cross-sectional side view of a wire grid polarizer, in which the wires comprise at least three different materials in each channel, forming at least three layers with two lowermost layers forming sub-channels therein, in accordance with an embodiment of the present invention;

FIG. 4 is a schematic cross-sectional side view of a wire grid polarizer, in which each channel includes at least two separate wires, each disposed on a different opposing sidewall of the channel, in accordance with an embodiment of the present invention;

FIG. 5 is a schematic cross-sectional side view of a wire grid polarizer, in which each channel includes at least two separate wires, each disposed on a different opposing sidewall of the channel, and each of the two separate wires is comprised of more than one wire, in accordance with an embodiment of the present invention;

FIG. 6 is a schematic cross-sectional side view of a wire grid polarizer, showing wires in the channels, and showing a channel that has a different depth, in accordance with an embodiment of the present invention;

FIG. 7 is a schematic cross-sectional side view of a wire grid polarizer, showing channels with wires removed for clarity, the channels and substrate are comprised of at least two layers of different materials, in accordance with an embodiment of the present invention;

FIG. 8 is a schematic cross-sectional side view of a wire grid polarizer, showing channels with wires removed for clarity, the channel sidewalls are disposed at a non-perpendicular angle to a surface of the substrate, in accordance with an embodiment of the present invention;

FIG. 9 is a schematic cross-sectional side view of a wire grid polarizer, showing channels with wires removed for clarity, the channel sidewalls are disposed at a non-perpendicular angle to a surface of the substrate, in accordance with an embodiment of the present invention;

FIG. 10 is a schematic cross-sectional side view of a wire grid polarizer, showing channels having a non-rectangular shape and with wires removed for clarity, in accordance with an embodiment of the present invention;

FIG. 11 is a schematic cross-sectional side view of a wire grid polarizer, showing channels having a non-rectangular shape and with wires removed for clarity, in accordance with an embodiment of the present invention;

FIG. 12 is a schematic top view of a wire grid polarizer comprised of multiple distinct wire grid polarizers, such as wire grid polarizers, in which wires of separate devices are arranged in a non-parallel manner, in accordance with an embodiment of the present invention;

FIG. 13 is a schematic top view of a wire grid polarizer comprised of multiple distinct wire grid polarizers, such as wire grid polarizers, in which there is a difference in channel pitch, a difference in material, a difference in channel depth, a difference in rib width, a difference in rib composition, a difference in channel alignment, or combinations of such differences between the devices.

FIG. 14 is a schematic cross-sectional side view of a wire grid polarizer, showing wires in the channels, and additional elements above the wires, in accordance with an embodiment of the present invention;

FIG. 15 is a schematic cross-sectional side view of a wire grid polarizer, showing wires in the channels, and additional elements above a surface of the substrate, in accordance with an embodiment of the present invention;

FIG. 16 is a schematic cross-sectional side view of a wire grid polarizer, showing wires in the channels, and an additional layer on top, in accordance with an embodiment of the present invention; and

FIG. 17 is a schematic perspective view of a wire grid polarizer, in accordance with an embodiment of the present invention.

### DEFINITIONS

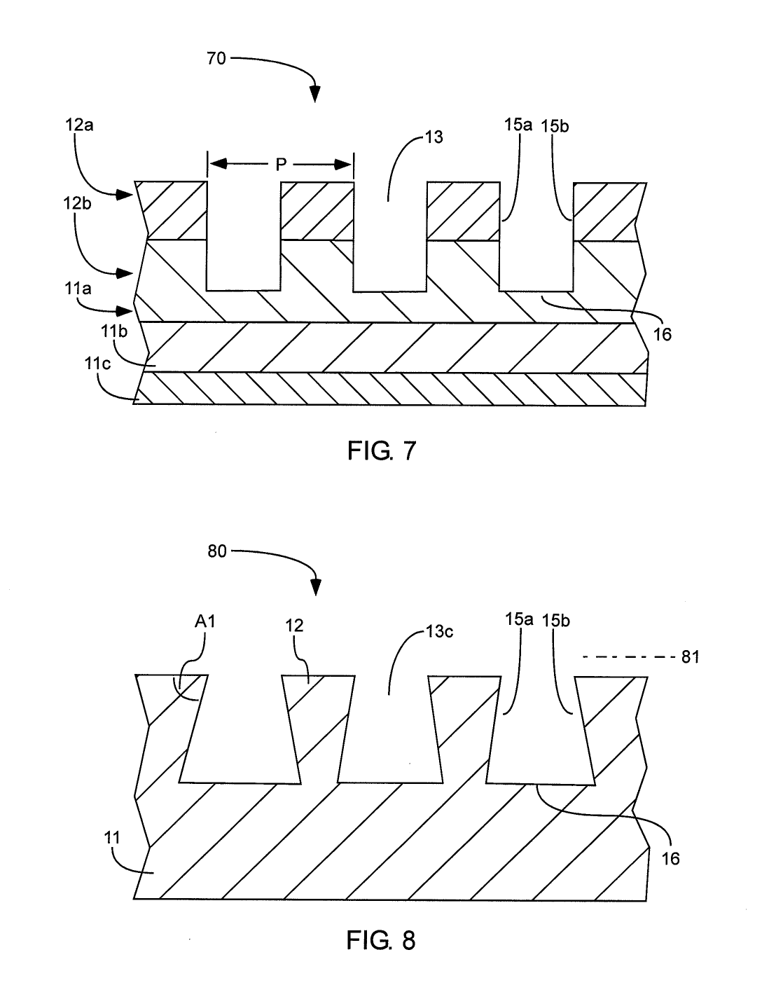

As used herein, the term “about” is used to provide flexibility to a numerical range endpoint by providing that a given value may be “a little above” or “a little below” the endpoint.
As used herein, the term “index of refraction” can mean an index of refraction of a single material or can mean an average, apparent, or composite index of refraction of a composite of different materials.
As used herein, the term “pitch” P, shown in FIG. 7, means a distance from one aspect or edge of a feature, such as a wire or channel to a corresponding aspect or edge of an adjacent feature of that same type.
As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result.
As used herein, the term “wire” means a segment of material with a length that is significantly longer than a width or diameter of the material.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

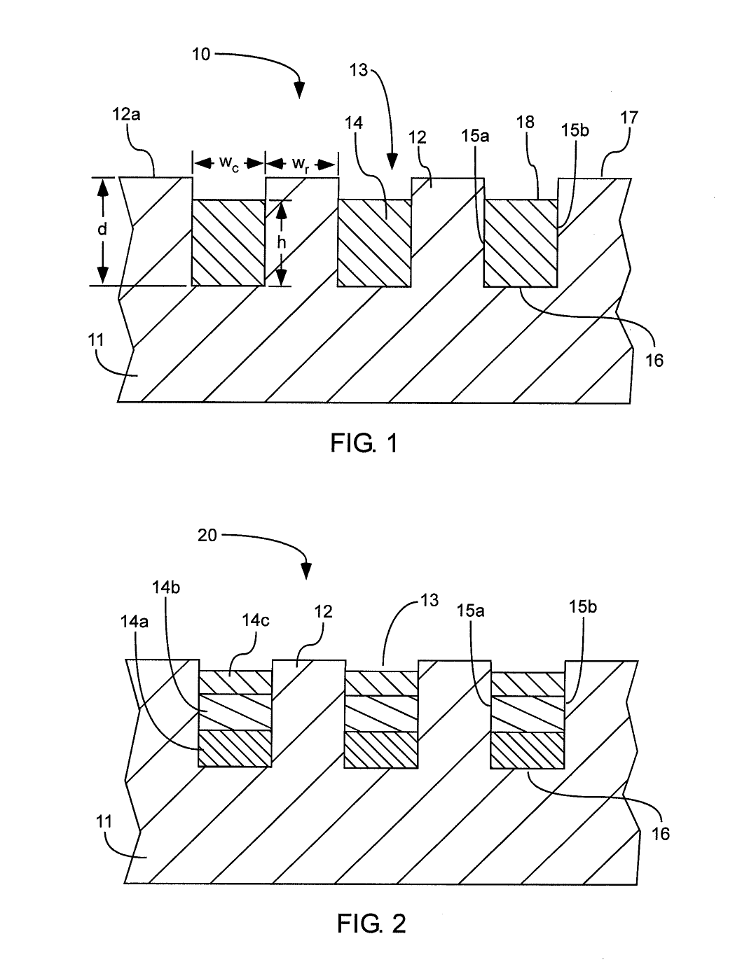

As illustrated in FIG. 1, a wire grid polarizer 10, such as a wire grid polarizer, is shown comprising a substrate 11 with an array of substantially parallel channels 13 extending into the substrate 11 from a top 17 of the substrate 11. The substrate 11 can be transparent to incident light, or a desired wavelength. The channels 13 can be formed by etching the substrate.

An array of substantially parallel ribs 12 is defined between the array of channels 13 and is integral with and extends from the substrate 11. Because the array of ribs 12 is integral with and extends from the substrate 11, there can be a continuous transition from substrate 11 to ribs 12 with no boundary region between substrate 11 and ribs 12. If ribs are formed on top of the substrate, even if made of the same material as the substrate, there may be a boundary region or disconnect between the ribs and substrate. Such a boundary region can result in weakening of the rib to substrate bond and also can adversely affect polarizer performance, thus it can be advantageous to etch channels in the substrate such that ribs are integral with the substrate.

The channels 13 can contain at least one material forming an array of substantially parallel wires 14. The wires 14 can be made of a material that will aid in polarization of incoming light. For example, the material of the wires 14 can be conductive, such as aluminum, silver or gold. The ribs 12 can separate the wires 14 into separate and discrete wires. Thus, the wire in one channel does not contact an adjacent wire in an adjacent channel. In one aspect, the material of the wires can be flush with the top of the substrate. In another aspect, the material of the wires can be recessed below the top of the substrate. In another aspect, the material of the wires can extend above the top of the substrate, while not extending laterally to contact another wire or channel. This design can allow for a more durable polarizer because substrate ribs 12 can support the wires 14.

Polarization and device durability can be improved by having wires 14 recessed below the top of the substrate 17, such that channel depth d can be greater tha wire height h, and the wires 14 extend all the way to the bottom 16 of the channels 13. Thus, wires 14 can be fully disposed in the channels 13 and can have a top surface that terminates below a top surface 17 of the substrate ribs 12. In one embodiment, the top surface 17 of the substrate ribs 12 can be free of wires 14.

Channel depth d minus wire height h can be greater than 5 nanometers in one embodiment, greater than 10 nanometers in another embodiment, greater than 25 nanometers in another embodiment, greater than 50 nanometers in another embodiment, or greater than 100 nanometers in another embodiment. Channel depth d minus wire height h can be greater between 5-20 nanometers in one embodiment, between 19-50 nanometers in another embodiment, or between 49-100 nanometers in another embodiment.

In one embodiment, the polarizer can have a low aspect ratio. Aspect ratio is defined as channel depth d divided by channel width w_{c}. For example, channel depth d can be at least 30 nm, channel width w_{c} can be less than 1000 nm, and ribs width wᵣ can be less than 1000 nm. In another embodiment, the polarizer can have a very high aspect ratio, such as greater than 5, greater than 10, greater than 15, or greater than 20, thus allowing for better contrast. For example, channel depth d can be greater than 1000 nanometers or greater than 2000 nanometers, the channel width w_{c} can be less than 100 nm, less than 50 nm, or less than 30 nm, and the rib width wᵣ can be less than about 100 nm, less than 50 nm, or less than 30 nm. A higher aspect ratio, without wire toppling during manufacturing or during handling, can be achieved due to support that the ribs provide to the wires. This higher aspect ratio can result in improved contrast.

In one embodiment of the present invention, channels 13 of the wire grid polarizers described herein can have a depth d of at least about 200 nm. In another embodiment of the present invention, channels 13 of the wire grid polarizers described herein can have a depth d of at least about 500 nm. In another embodiment of the present invention, channels 13 of the wire grid polarizers described herein can have a depth d of at least about 1000 nm. In another embodiment of the present invention, channels 13 of the wire grid polarizers described herein can have a width w_{c} of less than about 100 nanometers. In another embodiment of the present invention, ribs 12 of the wire grid polarizers described herein can have a width wᵣ of less than about 100 nanometers.

In one embodiment of the present invention, channels 13 can have a depth d of at least about 500 nm and a width w_{c} of less than about 100 nanometers, and ribs can have width wᵣ of less than about 100 nanometers.

The embodiment shown in FIG. 1 can have wires 14 that are partially protected from corrosion by channel sidewalls 15a-b and by channel bottom 16.

In one embodiment of the present invention, wires 14 of the wire grid polarizer can substantially fill the channels 13. The wires 14 can fill the channels up to a top surface 18 of the wires. In another embodiment, wires 14 of the wire grid polarizer do not fill the channels 13.

In one embodiment, wires 14 can comprise multiple layers of different materials, with one layer disposed on top of the other. For example, wires 14 can comprise two layers. In another embodiment, shown in FIG. 2, wires 14 of wire grid polarizer 20 can comprise at least three layers 14a-c in a stack with one layer disposed on top of another layer.

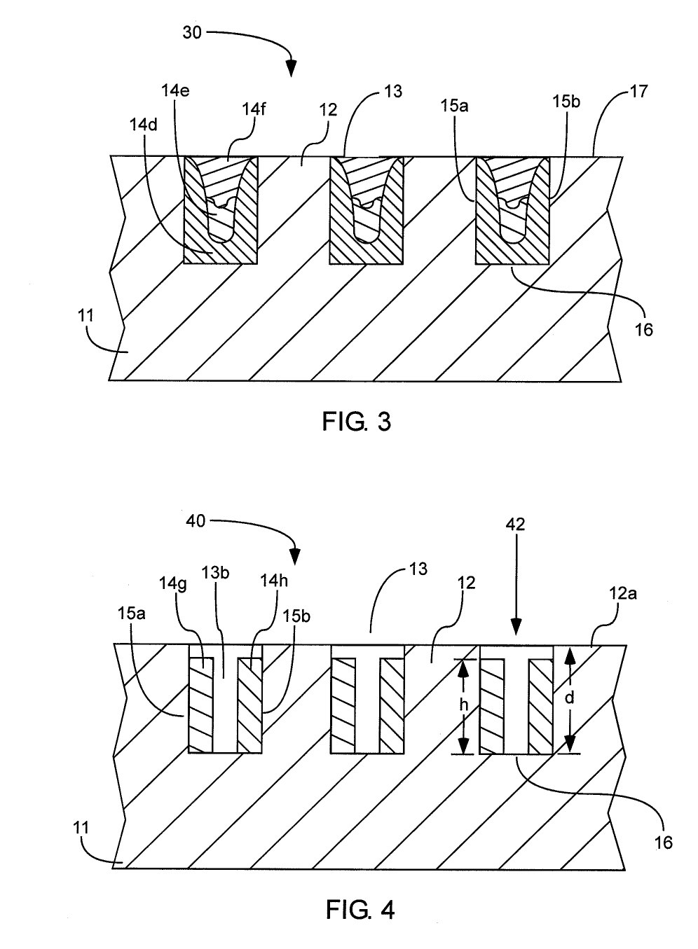

In one embodiment, wires 14 can comprise multiple layers of different materials, with sub-channels in lower layers and with one layer disposed on top of the sub-channel of the lower layer. For example, wires 14 can comprise two layers. In another embodiment, shown in FIG. 3, wires 14 of wire grid polarizer 30 can comprise at least three layers 14d-f in a stack with one layer disposed on top of the sub-channel of the lower layer. For example, the first layer can be disposed along the sidewalls and bottom of the channel, with a sub-channel therein in which the second and third layers are wholly or partially disposed. The second layer can be disposed in the sub-channel of the first layer, and can also have a sub-channel therein in which the third layer is wholly or partially disposed. In one aspect, one or all of the layers can extend all the way or substantially to the top of the channel or substrate 17, as shown by the first layer 14d. In another aspect, one or all of the layers can extend only partially to the top of the channel or substrate 17. This embodiment can be beneficial for tuning the wire grid polarizer 30 for specific wavelengths.

In the multilayer embodiments described above, each layer can serve a different purpose. For example, one layer can optimize polarization, and another can absorb one polarization. In another example, one layer can be optimized for one wavelength or group of wavelengths, and another layer can be optimized for another wavelength or group of wavelengths. For example, one layer can be optimized for infrared, another for visible, and another for ultraviolet light, thus allowing creation of a very broadband wire grid polarizer, such as a broadband polarizer. The layers of material can alternate between different conductive materials, or can alternate between conductive and dielectric materials.

As shown in FIG. 4, the wires 14 of the wire grid polarizer 40 can include two different wires 14g-h in each channel 13, each disposed on a different opposing sidewall 15a-b of the channel 13. A channel gap 13b can separate the two different wires 14g-h. Small separation of wires, or small pitch, in a wire grid polarizer can result in improved polarizer performance, especially at lower wavelengths. Separate but closely spaced wires in each channel can thus allow for improved polarizer performance. In one embodiment, one or both of the wires 14g-h extend to the top 17 of the rib 12. In another embodiment, the wires 14g-h terminate below the top 17 of the rib 12 (h<d).

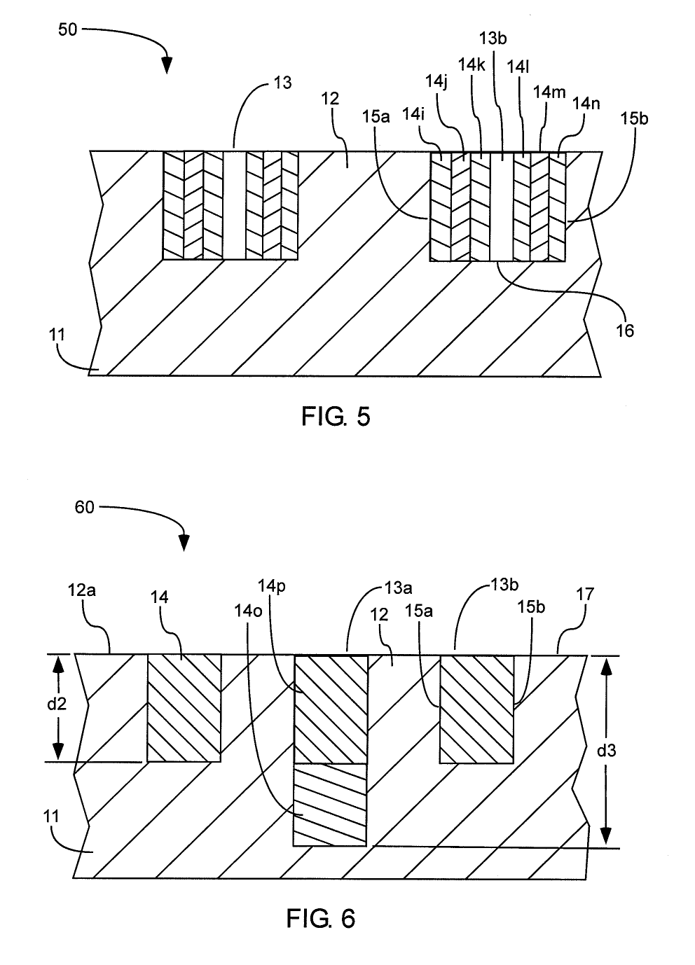

As shown in FIG. 5, the wires 14 of the wire grid polarizer 50 can include multiple wires 14i-n in each channel 13, with some of the wires 14i-k disposed on or near one sidewall 15a of the channel 13 and other of the wires 14l-n disposed on or near an opposing sidewall 15a of the channel 13. This embodiment, if used as a polarizer, can allow for very narrow spacing between wires, thus allowing for polarization of very low wavelengths. For example, wires 14i and 14k can be metallic and separated by an oxide or dielectric material 14j and wires 14l and 14n can be metallic and separated by an oxide or dielectric material 14m. Thus wires 14i and 14k and wires 14l and 14n can have a very small spacing between adjacent wires, and thus a very small pitch.

As shown in FIG. 6, channels 13 of the wire grid polarizer 60 need not have a single depth. One channel, or group of channels, can have one depth d2, a shallower depth, and can be defined as shallow channels 13b, and another channel, or group of channels, can have another depth d3, and can be defined as deep channels 13a.

In one embodiment, deep channels 13a include at least two different wire materials 14p and 14o. In one embodiment, a wire material 14o at a bottom of deep channels 13a can be different from any wire material in shallow channels 13b and a wire material at a top of deep channels 13a can be the same as wire material in shallow channels 13b. In one embodiment, deep channels 13a and shallow channels 13b can alternate.

This embodiment can be useful by allowing one material 14o at a bottom of deeper channels to have a different pitch than other material 14p in shallower channels. This can be useful to use one material for polarization and another material for another purpose, such as for a diffraction grating.

A difference in depth between deeper channels and shallow channels (d3-d2) can be at least 20 nm in one embodiment, at least 50 nm in another embodiment, or at least 100 nm in another embodiment.

The substrate can comprise a single, integral material in one embodiment. The substrate 11 can be comprised of multiple layers of different materials in another embodiment. If the layers are sufficiently thin and in a location where the substrate is etched, then the ribs 12 can also be comprised of multiple layers of different materials. For example, the wire grid polarizer 70 shown in FIG. 7 has a substrate with layers 11a-c. Ribs can also be comprised of multiple layers 12a-b. Either the substrate 11 can have multiple layers 11a-c, the ribs 12 can have multiple layers 12a-b, or both the substrate 11 and the ribs 12 can have multiple layers. Each layer can have a different optical purpose and a combination of the layers can enhance the polarization. (In FIG. 7, the array of wires has been removed for clarity.)

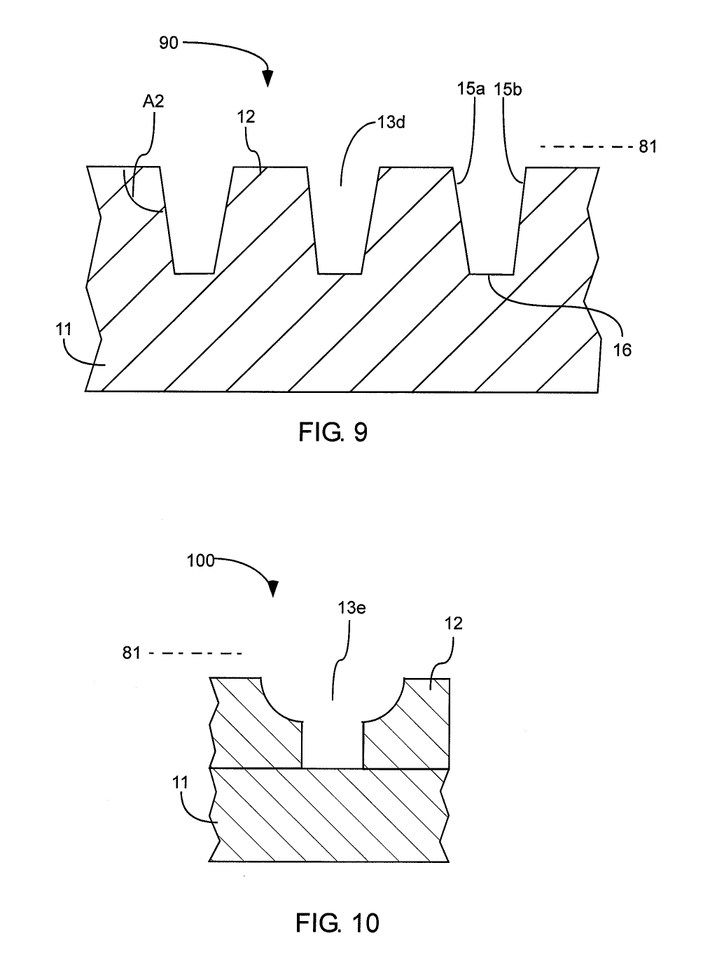

Although the wire grid polarizers shown in FIGS. 1-7 are drawn with rectangular shaped channels, all embodiments described herein can have channels of various shapes. For example, wire grid polarizer 80 shown in FIG. 8 has tapered shaped channels 13c due to an angle A1 of the channel sidewalls 15a-b that is less than about 80 degrees with respect to a surface parallel 81 to the substrate. (In FIG. 8, the array of wires has been removed for clarity.) Another example is shown in FIG. 9, wherein the wire grid polarizer 90 has tapered shaped channels 13d due to an angle A2 of the channel sidewalls 15a-b that is more than about 100 degrees with respect to a surface parallel 81 to the substrate. (In FIG. 9, the array of wires has been removed for clarity.)

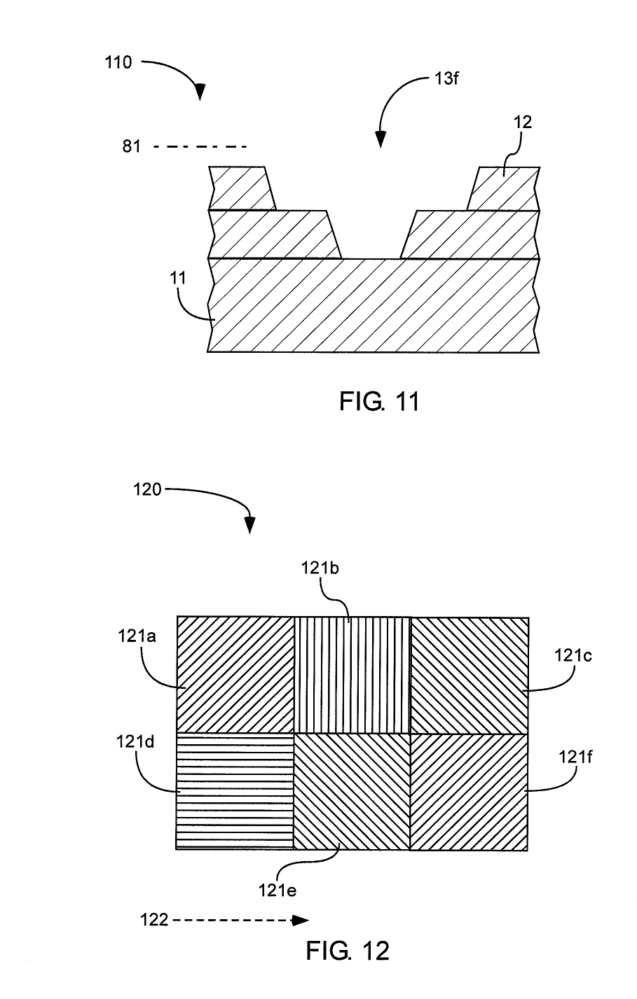

As shown in FIG. 10, channel 13e of wire grid polarizer 100, and as shown in FIG. 11, channel 13f of wire grid polarizer 110, can have a change in width, a change in angle, or both, so that at least a portion of the sidewall of the channel 13e and 13f is non-linear and non-orthogonal to a surface parallel 81 with the substrate. (In FIGS. 10 and 11, the array of wires have been removed for clarity.) The change in the sidewall can be distinct and can divide the cavity into one or more different portions with different characteristics, such as different shapes, different widths, different depths, different materials, different volumes, different angular sidewalls, or combinations thereof. Various shaped channels and methods of manufacture are described in U.S. Patent Publication Number 2010/0118390, incorporated herein by reference.

In the variously described channel shapes, light can react differently, or different wavelengths of light can react differently, in the different portions due to the different characteristics. Also, some shapes may be preferable due to ease of manufacturing.

As shown in FIG. 12, a pixelated wire grid polarizer 120 can include multiple sections of the wire grid polarizers described herein arranged in a plane with parallel channels of the wire grid polarizers aligned in at least two different directions. For example, the wire grid polarizer 120 in FIG. 12 shows wire grid polarizer 121a with channels at an angle of about 45 degrees, wire grid polarizer 121b with channels at an angle of about 90 degrees, wire grid polarizer 121c with channels at an angle of about 135 degrees, wire grid polarizer 121d with channels at an angle of about 0 degrees, wire grid polarizer 121e with channels at an angle of about 135 degrees, wire grid polarizer 121f with channels at an angle of about 45 degrees, all angles are relative to reference line 122. Pixelated polarizers can be used in vision equipment and interferometry.

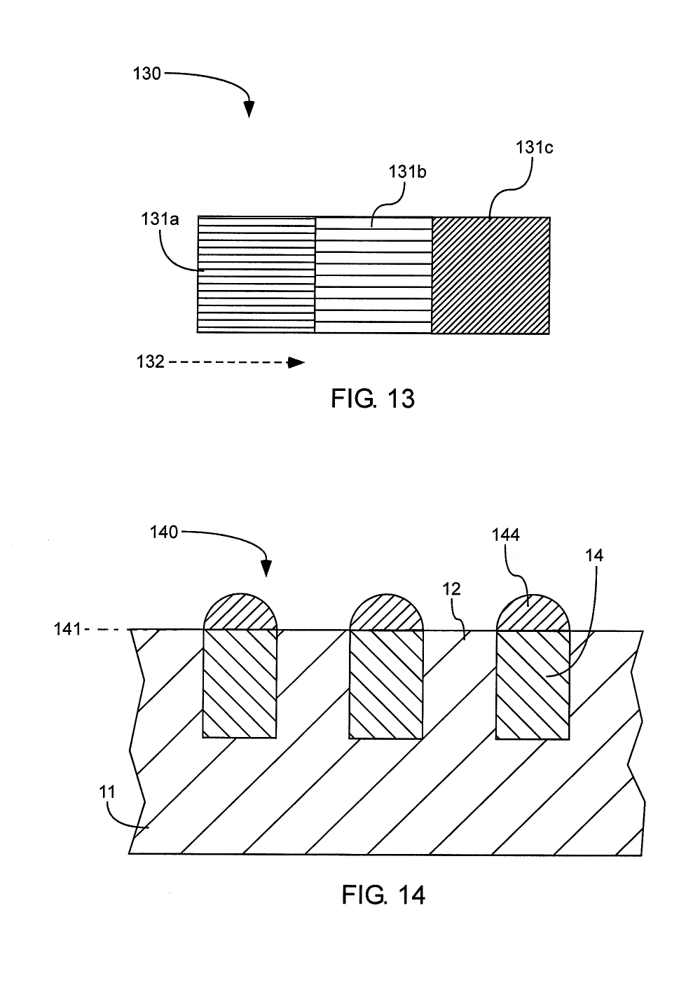

As shown in FIG. 13, a larger device 130, such as a pixelated polarizer, may be comprised of any wire grid polarizer described herein joined or associated together with at least one additional wire grid polarizer comprising a similar structure but having a difference in channel pitch, a difference in material, a difference in channel depth, a difference in rib width, a difference in rib composition, a difference in channel alignment, or combinations of such differences. This may be useful, for example, if one section is desired to be used for polarization of one wavelength, such as infrared, and another section is desired to be used for polarization of one wavelength, such as ultraviolet. In such case, different pitch may be used. For example, the wire grid polarizer 130 in FIG. 13 shows wire grid polarizer 131a with channels at an angle of about 0 degrees, wire grid polarizer 131b with channels at an angle of about 0 degrees, but with a different pitch tha wire grid polarizer 131a, and wire grid polarizer 131c with channels at an angle of about 45 degrees, and a different pitch tha wire grid polarizers 131 and 131b , all angles are relative to reference line 132.

As shown in FIG. 14, wire grid polarizer 140 can further comprise an additional array of substantially parallel elements 144 disposed above the wires 14 and above the top 141 of the substrate 11. The array of elements can further enhance the light such as improved polarization in some applications.

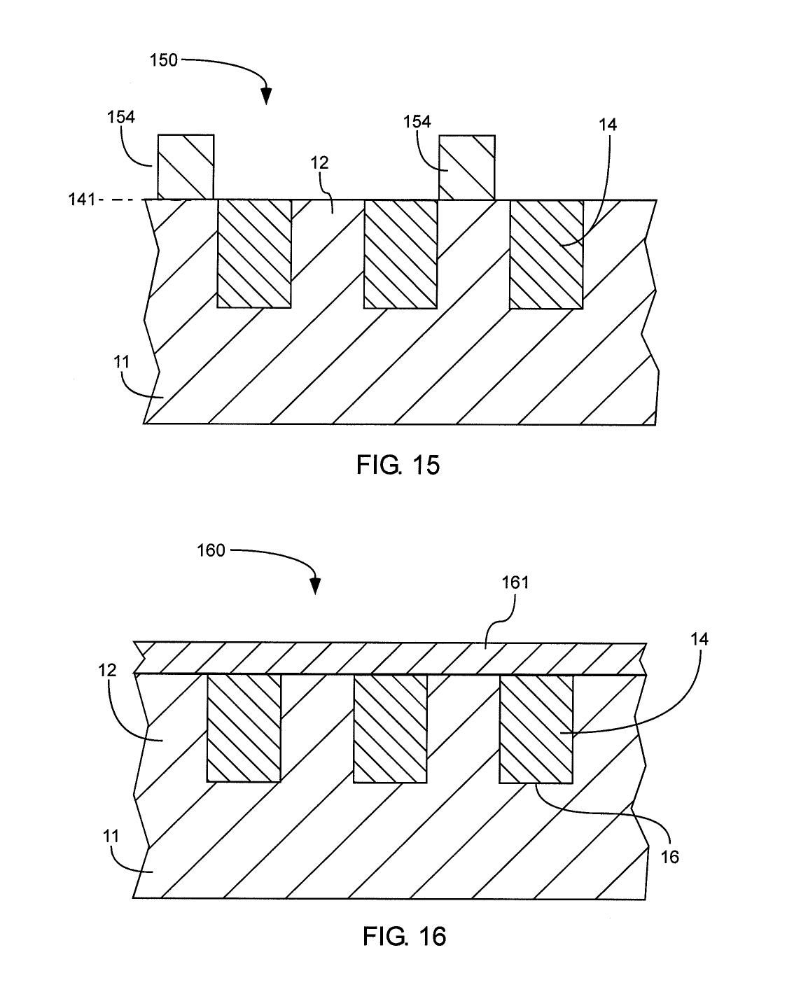

As shown in FIG. 15, wire grid polarizer 150, according to one of the embodiments described herein, can further comprise an additional array of substantially parallel elements 154 disposed above the top 141 of the substrate 11. The array of elements 154 need not be disposed on top of the wires and need not have the same pitch as the wires. This embodiment may be useful if a diffuse reflected light beam is desired. For example, wires 14 can polarize the light and elements 154 can act as a diffraction grating. Alternatively, wires 14 can act as a diffraction grating and elements 154 can polarize the light, if the wires have a greater pitch than the elements. For example, see U.S. Pat. Nos. 7,630,133 and 7,800,823, incorporated herein by reference.

As shown in FIG. 16, wire grid polarizer 160 has an additional layer or layers 161. The structure below the layer or layers 161 can be another of the structures described herein. The added layer 161 may be used for improved optical characteristics or for corrosion protection. For example, the layer can include an amino phosphonate for corrosion protection, as described in U.S. Pat. No. 6,785,050, incorporated herein by reference.

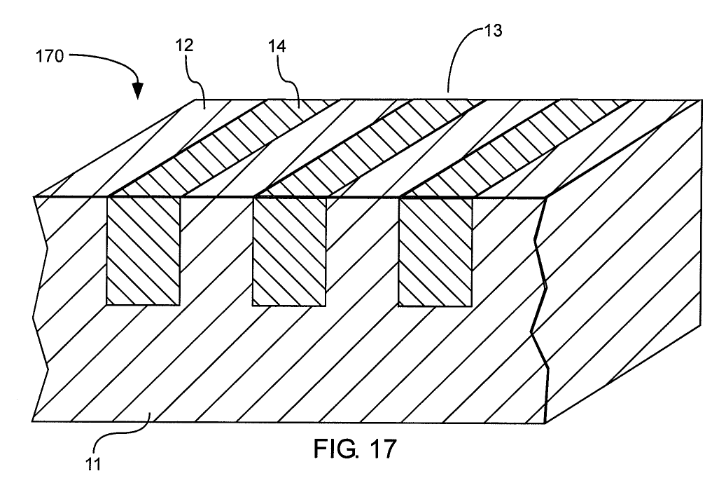

Wire grid polarizer 170 shown in FIG. 17 illustrates the 3 dimensional structure of the various wire grid polarizers described herein.

A wire grid polarizer having an index of refraction of wires n_{w} that is greater than an index of refraction of gaps n_{g} between wires (n_{w}>n_{g}) can allow for polarization of light. Alternatively, a wire grid polarizer having an index of refraction of wires n_{w} that is less than an index of refraction of ribs nᵣ between wires (n_{w}<nᵣ) can allow for polarization of light. Thus, in the various embodiments described herein, an index of refraction of the wires n_{w} can be greater than an index of refraction of the ribs nᵣ or an index of refraction of the wires n_{w} can be less than an index of refraction of the ribs nᵣ. In one embodiment, a difference between the index of refraction of the wires n_{w} and an index of refraction of the ribs nᵣ can be greater than 0.5 (n_{w}−nᵣ>0.5 or nᵣ−n_{w}>0.5). In another embodiment, a difference between the index of refraction of the wires n_{w} and an index of refraction of the ribs nᵣ can be greater than 2 (n_{w}−nᵣ>2 or nᵣ−n_{w}>2). The difference in index of refraction can be controlled by the type of material selected for the ribs 12 and the type of material selected for the wires 14.

### How to Make:

Channels 13 of the wire grid polarizer 10 of FIG. 1 can be made by patterning and etching. For example, a hard mask, such as aluminum, an oxide, or a nitride, can be applied by sputtering. A resist can be spun on the metal. The resist can be patterned by lithography. The resist and metal can be etched. The etch can continue into the substrate, thus creating the channels 13. The resist and metal can be removed by selective etch or chemical dissolution.

Wires 14 in the channels 13 can be formed by a conformal deposition process such as chemical vapor deposition or atomic layer deposition. The deposition can be aided by rapid thermal anneal. An etch can remove wire 14 material on ribs 12 at the substrate surface 12a while leaving wire material in the channels 13. Wire 14 material can remain in the channels 13 during removal of wire 14 material on the ribs 12 because of the greater depth of material in channels 13 than on top of ribs 12.

Tops of the wires 18 can be lowered below a top surface 17 of the substrate ribs 12 by selective etching the wires. For example, a chemical etch in dilute base such as potassium hydroxide may be used. Another example is reactive ion etching and adjusting the etch chemistries to bias the selectivity of the metal to the oxide.

Wire grid polarizers 20 and 30 of FIGS. 2-3 can be made similarly to wire grid polarizer 10 by application of multiple layers of different materials in the deposition process, then etching similarly as described with wire grid polarizer 10.

Wire grid polarizer 40 of FIG. 4 can be made similarly to wire grid polarizer 10 by application of a thinner layer in the deposition process such that wire material is coated on sides 15a-b and bottom 16 of each channel 13 but does not fill the channel 13b. An anisotropic etch can then remove wire material both on top 12a of ribs and wire material within a center of channels 13b down to a bottom 16 of each channel, while leaving wire material on channel sidewalls 15a-b. The material remains on channel sidewalls 15a-b due to the large depth of wire material along sidewalls 15a-b in the direction 42 of the etch compared to a thickness of wire material on top of ribs 12a and at the bottom 41 of the channels.

Wire grid polarizer 50 of FIG. 5 can be made similar to wire grid polarizer 40. The process for making wire grid polarizer 40 is repeated multiple times to create more than one adjacent wire on a sidewall of a channel. Each subsequent step of deposition and etching can be done with the same or with a different material than the previous step. A dielectric material in between steps with a metallic material can result in very small pitch between metal wires. This can provide very good polarization of low wavelengths.

Wire grid polarizer 60 of FIG. 6 can be made by a similar process as for wire grid polarizers above except that after forming the channels 13, a second mask is used to create deeper channels in only select channels. Wire formation can be similar to that described above. Multiple wire materials may be in one channel, as shown by 14o and 14p with only a single material in adjacent channels by first applying wire material 14o, then etching so that all or much of wire material 14o is removed from shallower channels but not from deeper channels. A second wire material 14p may then be applied and etched to remove down to a top surface of the substrate 17 while leaving this wire material 14p in the channel.

Wire grid polarizer 70 of FIG. 7 can be made by applying multiple layers of material on a substrate, the added layers becoming part of the substrate. Remaining manufacturing can be completed as described above or below for the various embodiments described. Whether the multiple layers exist in the final ribs 12, the substrate 11, or both, depends on a thickness of the layers and a depth of the etch.

Wire grid polarizer 80 of FIG. 8, can be made by an increasingly isotropic etch as the etch progresses deeper into the channels 13c. Wires can be formed as described previously.

Wire grid polarizer 90 of FIG. 9, can be made by an initial isotropic etch that undercuts the mask followed by a decreasingly isotropic etch as the etch progresses deeper into the channels 13d. Wires can be formed as described previously.

Wire grid polarizer 100 of FIG. 10, can be made by an initial isotropic etch that undercuts the mask followed by an anisotropic etch to form channel 13e. Wires can be formed as described previously.

Wire grid polarizer 110 of FIG. 11, can be made by a resist erosion isotropic dry etch undercutting a first mask, removal of the first mask, followed by application of a second mask. An isotropic dry etch then undercuts the second mask and the second mask is removed. Wires can be formed as described previously.

Wire grid polarizers 120 of FIGS. 12 and 130 of FIG. 13, can be made by any of the methods described herein for forming optical structures, then adhering optical structures together with the desired polarizer pattern.

Wire grid polarizer 140 of FIG. 14, can be made by any of the methods described herein, then performing selective or preferential deposition to deposit element 104 material on top of the wires 14 with minimal or no deposition on top of the ribs 12.

Wire grid polarizer 150 of FIG. 15, can be made by any of the methods described herein, then applying a second material and patterning and etching to form the elements 154.

The wires 14 and/or the elements 104 can be conductive. The wires 14 and/or the elements 104 can comprise a metal. The wires 14 and/or the elements 104 can comprise aluminum, silver, gold or copper. The wires can also be a metal alloy. The wires can be a dielectric or a plasmon resonance material.

The wires 14 and/or the elements 104 can be formed of or can include a dielectric and/or absorptive material. The wires 14 and/or the elements 104 can be formed of: aluminum oxide; antimony trioxide; antimony sulphide; beryllium oxide; bismuth oxide; bismuth triflouride; cadmium sulphide; cadmium telluride; calcium fluoride; ceric oxide; chiolite; cryolite; germanium; hafnium dioxide; lanthanum fluoride; lanthanum oxide; lead chloride; lead fluoride; lead telluride; lithium fluoride; magnesium fluoride; magnesium oxide; neogymium fluoride; neodymium oxide;

praseodymium oxide; scandium oxide; silicon; silicon oxide; disilicon trioxide; silicon dioxide; sodium fluoride; tantalum pentoxide; tellurium; titanium dioxide; thallous chloride; yttrium oxide; zinc selenide; zinc sulphide; and zirconium dioxide, and combinations thereof.

The wires 14 and/or the elements 104 can be formed of or can include a carbide, chloride, fluoride, nitride, oxide, sulfide, etc.

It is believed that cadmium telluride, germanium, lead telluride, silicon oxide, tellurium, titanium dioxide, silicon, cadmium sulfide, zinc selenide, and zinc sulfide are appropriate for the ultra-violet range; cadmium telluride, germanium, lead telluride, silicon oxide, tellurium, titanium dioxide, and silicon are appropriate for the visible range; and magnesium fluoride, aluminum oxide, cadmium telluride, germanium are appropriate for the infrared range.

In another aspect, the wires 14 and/or the elements 104 can be formed of or can include a material or materials selected from: silicon nitride, titanium nitride, titanium carbide, silicon carbide, tantalum, cupric oxide, cuprous oxide, cupric chloride, cuprous chloride, cuprous sulfide, titanium, tungsten, niobium oxide, aluminum silicate, boron nitride, boron oxide, tantalum oxide, carbon and combinations thereof. In addition to the material listed herein, ionic states of the material can also be included, particularly for transition metal oxides, hydrides, nitrides, salts, etc.

Many of the materials mentioned above can be deposited using various deposition techniques such as sputtering, Chemical Vapor Deposition (CVD), or evaporation to produce a material of the wires or elements that are not stoichiometric. This can be used to produce dielectric wires or elements that have different optical properties than the common bulk stoichiometric material. For example, it is possible to produce a titanium oxide dielectric film by sputtering that is oxygen-starved, and therefore has much higher optical absorption than the standard film. Such a film can be used to produce a wire grid that strongly absorbs one polarization rather than strongly reflecting the same polarization using the present invention. In a similar manner, it is possible to do the same thing with other metal oxides such as zirconium oxide, magnesium oxide, silicon oxide, etc. Similar effects can also be accomplished with metal fluorides such as magnesium fluoride, with metal nitrides such as silicon nitride, and with metal sulphides, silicides, or selenides.

The substrate 11 can be transparent to incident light. The substrate 11 can be glass, quartz, or polymer. The substrate 11 can be flexible. Furthermore, the substrate 11 can have a refractive index (or index of refraction) nₛ. For example, a glass substrate (Bk7) has a refractive index nₛ of 1.52 (at 550 nm). (It will be appreciated that the refractive index varies slightly with wavelength.)

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1-3. (canceled)

4. A wire grid polarizer device, comprising:
a) a substrate substantially transmissive to incident light;
b) an array of substantially parallel channels extending into the substrate from a top of the substrate;
c) an array of substantially parallel ribs defined between the array of channels and extending from the substrate;
d) at least six different wires disposed in each channel, separated into two groups including at least three wires in each group;
e) a channel gap separating the two groups;
f) a top surface of the ribs being free of the wires; and
g) each group disposed on a different opposing sidewall of the channel.

5. The device of claim 4, wherein each group includes at least two metallic wires separated by an oxide or dielectric material.

6. (canceled)

7. A wire grid polarizer device, comprising:
a) a substrate substantially transmissive to incident light;
b) an array of substantially parallel channels extending into the substrate from a top of the substrate;
c) an array of substantially parallel ribs defined between the array of channels and extending from the substrate;
d) wires fully disposed in the channels;
e) a top surface of the ribs being free of the wires;
f) the wires substantially fill the channels up to a top surface of the wires;
g) the wires comprise at least three different materials in each channel; and
h) the at least three different materials form at least three layers in a stack with one layer disposed on top of another layer.

8. A wire grid polarizer device, comprising:
a) a substrate substantially transmissive to incident light;
b) an array of substantially parallel channels extending into the substrate from a top of the substrate;
c) an array of substantially parallel ribs defined between the array of channels and extending from the substrate;
d) wires fully in the channels;
e) a top surface of the ribs being free of the wires;
f) the wires comprise at least two different materials in each channel; and
g) the at least two different materials form at least two layers including a first layer having a sub-channel therein, and a second layer disposed in the sub-channel of the first layer.

9. (canceled)

10. The device of claim 8, wherein the channels are tapered due to an angle of channel sidewalls that is less than about 80 degrees with respect to a surface parallel to the substrate, such that the channels broaden from a top of the ribs to a bottom of the channels.

11. The device of claim 8, wherein the channels are tapered due to an angle of channel sidewalls that is more than about 100 degrees with respect to a surface parallel to the substrate.

12-13. (canceled)

14. (canceled)

15-20. (canceled)

21. The device of claim 8, wherein the second layer is wholly disposed in the sub-channel of the first layer.

22. The device of claim 8, wherein:
a) the wires comprise at least three different materials in each channel;
b) the at least three different materials form at least three layers; and
c) a third layer is disposed in a sub-channel of the second layer.

23. The device of claim 8, wherein:
a. the wires comprise at least three different materials in each channel;
b. the at least three different materials form at least three layers;
a) the first layer is disposed along sidewalls and a bottom of the channel; and
b) the second layer and a third layer are disposed in the sub-channel of the first layer.

24. The device of claim 23, wherein the second layer and a third layer are wholly disposed in the sub-channel of the first layer.

25. The device of claim 23, wherein the second layer includes a sub-channel and the third layer is disposed therein.

26. The device of claim 25, wherein the third layer is wholly disposed in the sub-channel of the second layer.
